(19) United States
(12) Patent Application Publication
(10) Pub. No.: US 2006/0271946 A1
(43) Pub. Date: Nov. 30, 2006

(54) Method and system of monitoring media units

(76) Inventors: Richard Woundy, North Reading, MA (US); John G. Bevilacqua, Boulder, CO (US)

Correspondence Address: BROOKS KUSHMAN P.C., 1000 TOWN CENTER, TWENTY-SECOND FLOOR, SOUTHFIELD, MI, 48075, US

(21) Appl. No.: 11/136,050

(22) Filed: May 24, 2005

(51) Int. Cl. H04N 7/16; H04H 9/00

(52) U.S. Cl. 725/9; 725/13; 725/10

(57) ABSTRACT

A method and system of monitoring media units. The method and system relating to configuring to the media units to log data associated with particular events and to store the data in a manner suitable for transmission to a network element. The network element may include features to facilitate monitoring the media units as a function of the logged data.

### BACKGROUND OF THE INVENTION

1. Field of the Invention

The present invention relates to methods and systems of monitoring media units.

2. Background Art

Media providers, such as cable/satellite television, high-speed data, and other servers providers, typically deploy one or more media units to facilitate extending services to their customers. The media units may be transmission related features, such as routers, bridges, hubs, Cable Modem Termination Systems (CMTS), network provisioning units (NPUs), conditional access routers (CARs), and the like. The media units may also be customer related or customer premises equipment, such as settop boxes (STBs), cable modems (CMs), computers, digital or personal video recorders (DVRs, PVRs), media terminal adapters (MTAs), outlet digital adapters (ODAs), and the like.

The use of these and other media units may be dependent on the services provided and the features required to support the operation thereof. The media providers face numerous challenges in supporting systems having such features. Cable providers, for example, may be required to support millions of media units. The support thereof may include monitoring performance, troubleshooting problems and/or malfunctions, installation, etc.

One difficulty with supporting the media units in this manner is that the media providers are unable to query data from the media units. The ability to query data from the media units can be important in diagnosing and correcting problems and other issues associated with supporting operations. In the past, the media providers either relied on customer descriptions of the problem or operational states and/or technicians or other personnel of the media provider were dispatched to the media unit.

### SUMMARY OF THE INVENTION

One aspect of the present invention related to method of monitoring media units. The method may include configuring the media units to respond to a number of events and to log data in response to occurrence of one or more of the events. The method may further include configuring the media units to transmit at least a portion of the logged data to a network element for monitoring.

The method may include configuring one or more of the media units to transmit the logged data upon receipt of a query from the network element. For example, the media units may be configured to automatically transmit the logged data to the network element.

The method may include configuring the network element to periodically query the media units for logged data and to identify support issues. For example, the support issues may be determined by the network element as a function of the logged data retrieved through the periodic querying.

The method may include configuring the network element with a graphical user interface to include a number of selectable events which may be selected by an operator, and configuring the network element to query the media units as a function of the events selected by the operator through the graphical user interface.

One aspect of the present invention relates to an electronic system of providing electronic services to customers. The services may be provided over an electronic network and with the assistance of a number of media units. The system may include the media units being configured to respond to a number of events and to log data in response to occurrence of one or more of the events. The system may include a network element configured for receiving the logged data from the media units and for outputting information associated with monitoring the media units, the outputted information being determined as a function of the logged data.

The system may include one or more of the media units being configured to transmit the logged data upon receipt of a query from the network element. For example, the media units may be configured to automatically transmit the logged data, such as as a function of one or more events occurrences.

The system may include the network element being configured to periodically query the media units for logged data.

The system may include the network element being configured to include a graphical user interface having a number of selectable events which may be selected by an operator. The network element may be configured to query the media units as a function of the selected events and/or configured to program the media units to log data as a function of the selected events for subsequent transmission to the network element.

The system may include one or more of the media units being STBs configured to communicate with the network element according to SNMP, HTTP, Syslog, or TFTP protocols.

One aspect of the present invention relates to a method of monitoring settop box (STB) activities. The method may include configuring the STB to respond to a number of events, configuring the STB to log data in response to occurrence of one or more of the events, and configuring the STB to store the logged data in a manner suitable for use in monitoring activities of the STB.

The method may include configuring the STB to manage the logged data by storing the logged data for subsequent communication.

The method may include configuring the STB to include network communication capabilities and configuring a network element to request and retrieve at least a portion of the stored data from the STB according to the network communication capabilities.

The method may include configuring the STB to automatically transmit at least a portion of the logged data to a network element, such as by configuring the STB to automatically transmit the logged data in response to one or more events.

The method may include configuring the STB to transmit the logged data according to SNMP, HTTP, Syslog, or TFTP protocols.

The method may include configuring the STB to store the logged data on a memory of the STB. For example, the logged data may be stored on a volatile or non-volatile memory as a function of the event associated therewith.

The above features and advantages, along with other features and advantages of the present invention, are readily apparent from the following detailed description of the invention when taken in connection with the accompanying drawings.

### BRIEF DESCRIPTION OF THE DRAWINGS

FIG. 1 illustrates a system of providing services to one or more customers in accordance with one non-limiting aspect of the present invention;

FIG. 2 illustrates an exemplary cable system in accordance with one non-limiting aspect of the present invention;

FIG. 3 illustrates a media unit in accordance with one aspect of the present invention; and

FIG. 4 illustrates a flowchart of a method of monitoring media units in accordance with one non-limiting aspect of the present invention.

### DETAILED DESCRIPTION OF THE PREFERRED EMBODIMENT(S)

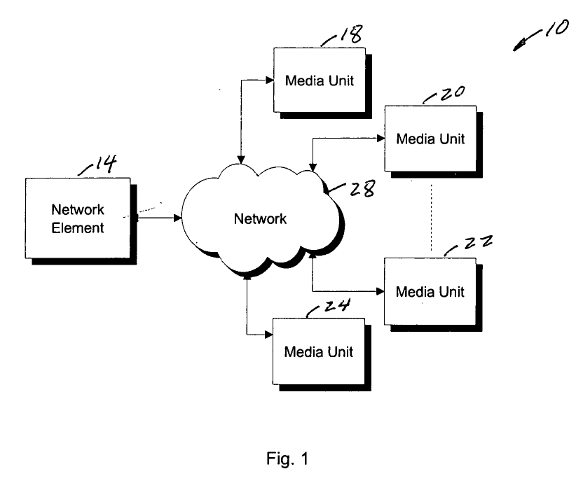

FIG. 1 illustrates a system 10 of providing services to one or more customers in accordance with one non-limiting aspect of the present invention. The system 10 may include a network element 14 which communicates with a number of media units 18-24 through a network 28. For example, the system 10 may be configured to support cable television operations where the network element 14 may be a headend unit or other feature associated with a cable operator which communicates with media units 18-24 which provide or facilitate services between the cable operator and one or more customers.

The network element 14 may include a number of features associated with providing services to the customers. The network element 14 may be associated with a cable system, satellite system, or other system associated with providing services to the customers. It may include any number of processors, memories, user interfaces, and other features to facilitate the operation thereof. The network element 14 may be programmed and controlled to perform any number operations and functions associated with providing any number of services to the customers.

The media units 18-24 may include any number of devices and elements associated with supporting the services provided by the network element. For example, the media units may be settop boxes (STBs), modems, cable modems (CMs), computers, digital or personal video recorders (DVRs, PVRs), media terminal adapters (MTAs), outlet digital adapters (ODAs), cable modem termination systems (CMTSs), network provisioning units (NPUs), conditional access routers (CARs), and others.

The network 28 may include any number of features and options to support signal communications between the network element 14 and the media units 18-24. The network 28 may include terrestrial and extraterrestrial components and infrastructures. It may include cable lines, telephone lines, and/or satellite or other wireless architectures. The network 28 may be associated with other private and/or public networks, such as the Internet and provider specific private networks.

The network element 14, network 28 and/or media units 18-24 may be configured to operate according to or support the operation of any number of protocols, applications, and procedures, including applications such as linear and non-linear television programming (cable, satellite, broadcast, etc.), Video on Demand (VOD), interactive television (iTV), interactive gaming, pay-per-view (PPV), and protocols such as, Hyper Text Transfer Protocol (HTTP), Dynamic Host Configuration Protocol (DHCP), Syslog, Simple Network Management Protocol (SNMP), Trivial File Transfer Protocol (TFTP), Data Over Cable Service Interface Specification (DOCSIS), Domain Name Server (DNS) applications, DOCSIS Settop Gateway (DSG), out-of-band (OOB) messaging, and others.

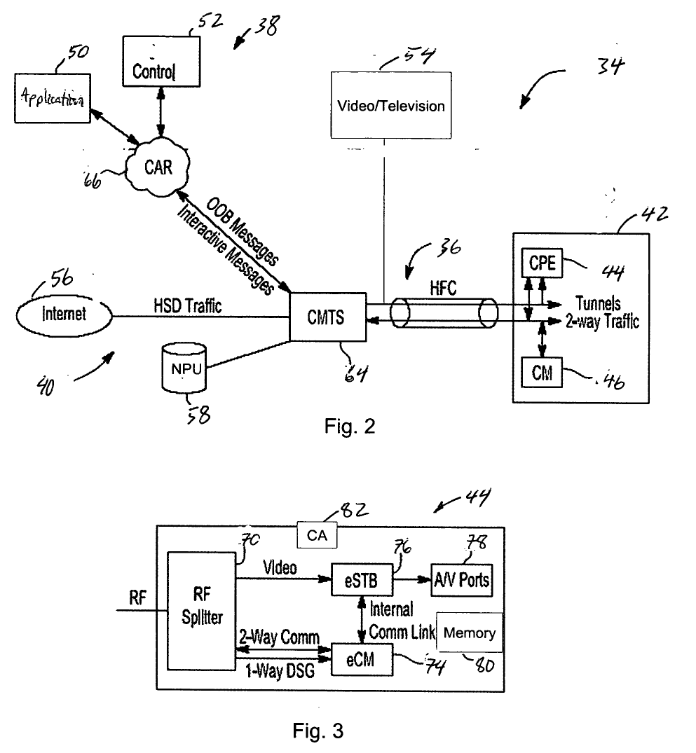

FIG. 2 illustrates an exemplary cable system 34 in accordance with one non-limiting aspect of the present invention. The system 34 may include a management/application portion 38 and a High Speed Data (HSD) portion 40 that respectively provide management/application and HSD services over a hybrid fiber coax (HFC) 36, or other communication medium, to a subscriber station 42.

The subscriber station may include any number of media units, including customer premises equipment (CPE) 44 and a cable modem (CM) 46. The subscriber station 42 generally relates to all features, devices, and applications located at a customer location which interface with one or both of the media provider and/or customer to support media services associated with the cable system provider. Multiple subscriber stations having any number of features and devices may be supported through signals communicated over the HFC network.

The management/application portion 38 may include an application portion 50, a control portion 52, and a video/television portion 54. The control portion 52 may include features to facilitate controlling, provisioning, managing, and securing the CPE 44 through OOB messaging and other protocols. The application portion 50 may include features associated with providing applications to the CPE 44, such as VOD, iTV, and other services. The video/television portion 54 may cooperate with the application portion 50 and control portion 52 to support video operations associated therewith and/or it may act independently to provide television, music, video, and other multimedia services to the CPE 44.

The HSD network 40 may provide data services for the system 34, including services for the CM 46 to access the Internet 56. It may include a network element, such as a network provisioning unit (NPU) 58. The NPU 58 may be configured to support any number of activities associated with the media units. In accordance with one non-limiting aspect of the present invention, the NPU 58 may include capabilities to facilitate configuring the media units, such as by distributing bulk configurations files to one or more the media units. It may be configured to communicate with the media units through any number of protocols, applications, and communication mediums, including DHCP, HTTP, SNMP, TFTP, and the like.

In addition to the media units at the subscriber station 42, one of the transmission related media units may be a CMTS 64. The CMTS 64 may be configured to send and receive signals over the HFC network 58, such as between the Internet 56 and the CPE 44 and the CM 46. In general, the CMTS 64 transfers IP packets from the HSD network 40 and the management/application network 38 to the CPE 44 and CM 46 for processing. Preferably, the signals are outputted from the CMTS 64 on downstream output channels, which may include one-way output data tunnels, such as for OOB messaging. In addition, the CMTS 64 may be configured to receive signals from the CPE 44 and the CM 46 to support two-way communication therewith, such as for transfer of IP packets from the STB and/or the CM to the Internet 56 and/or the management/application network 38.

Another one of the transmission related media units may be a CAR 66. The CAR 66 may be configured to connect the management network 38 to the CMTS 64. The CAR 66 may transport signals therebetween using IP protocols, and optionally, it may provide firewall separation for the VOD or STB controller portions and from the HSD network 38, enhancing security from any devices attempting to associate with devices and signaling on the management network. In operation, signaling traffic transported between the management network 38 and the CMTS 64 may be wrapped into addressable packets, such as Ethernet, IP, or other packets.

FIG. 3 illustrates the CPE 44 in accordance with one aspect of the present invention. The CPE 44 may be configured to communicate with the CMTS 64 through digital cable signals, such as through signaling defined by DOCSIS, DSG, and/or through other protocols authorized through DHCP registration. The CPE 44 may include a radio frequency (RF) splitter 70, an embedded cable modem (eCM) 74, am embedded settop box (eSTB) 76, audio visual (A/V) ports 78, a memory (volatile and/or non-volatile) 80, and an optional conditional access (CA) unit 82.

The RF splitter 70 may be configured to split RF signals into two portions—one for OOB control functions and two-way application traffic and one for video delivery. The OOB and two-way application traffic may be relayed to the eCM 74 and the video may be separately relayed to the eSTB 76. The eSTB 76 may be configured to manipulate signals and output video and other media signals to a media output device (not shown) or other device connected to the A/V ports 78, such as to a television (TV), digital video recorder (DVR), personal video recorder (PVR), or the like.

The eCM 74 may be configured to process and control other signals, such as DOCSIS and other IP packets, and bridge or relay the signals to the eSTB 76 through an internal communications link. The communications link may be used to transfer signals received through data tunnels, such as those tuned to by the eCM 74 to the eSTB 76, so that OOB messaging signals associated therewith can be delivered to the eSTB 76 for processing. The eCM 74 may include network communication capabilities for bidirectional communication of data signals with the CMTS 64.

The CA unit 82 may be configured to provide conditional access control for the CPE 44. It can be a CableCard, SmartCard, or other item for controlling security and access to the data, video, and control signals transmitted over the HFC 36. It is illustrated as a standalone item, however, it can be included with or embedded on the eSTB 76 or the eCM 74 to perform similar functions.

The eCM 74, eSTB 76, and CA unit 82 may be logically separate entities, however, they may physically share hardware and software. Other items, such as control logic and applications may be included on the CPE 44 for controlling operation of the eSTB 76 and/or the eCM 74.

Of course, the foregoing is merely provided for exemplary purposes and is intended to disclose only a portion of the devices, applications, and configurations which may be used with the network element and media units to provide and/or support customer services. The present fully contemplates any number of configurations and configurations including more or less of the foregoing features.

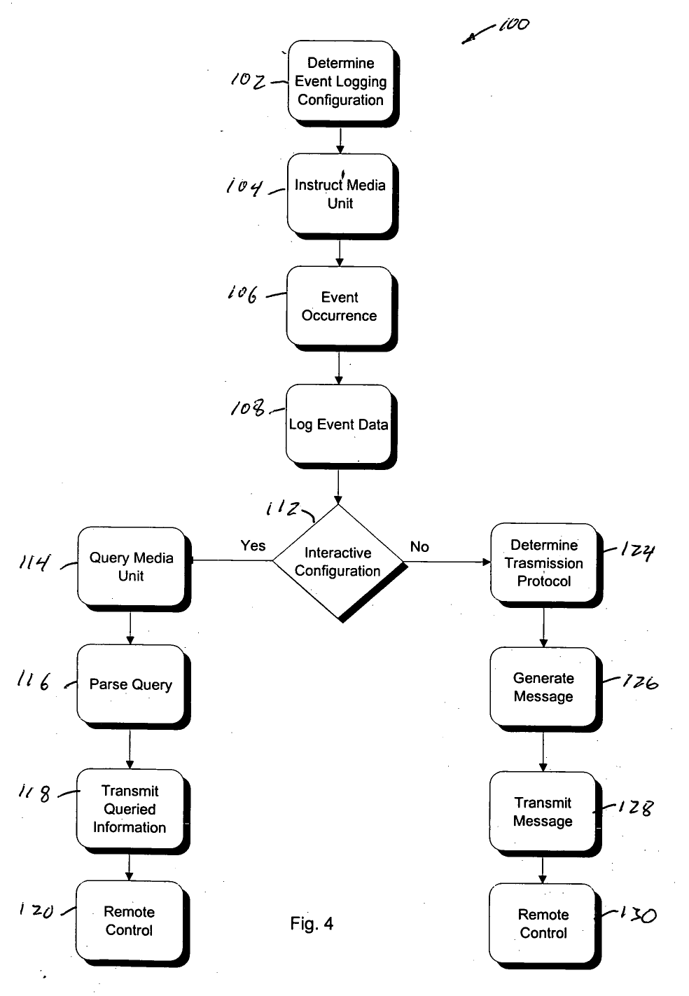

FIG. 4 illustrates a flowchart 100 of a method of monitoring the media units in accordance with one non-limiting aspect of the present invention. The method, for exemplary purposes, may, at some locations, refer to monitoring STBs associated with a cable system. As described above, the present invention is not intended to be limited to STBs and cable systems, and fully contemplates applying the methods of the present invention in any number of environments and number of media units.

Block 102 relates to determining event logging configurations for one or more of the media units. The event logging configurations generally refer to parameters, definitions, and other logic that may be associated with instructing the media units to log (record, store, etc.) data associated with a predefined number of events. Events may be generally characterized as any number of measurable, quantifiable, or other detectable conditions which can be determined by the media units. Accordingly, and depending on the media unit and its capabilities, the number of possible events may be rather large, and in some cases, dependent on operating conditions, environments, processing limitations, and other constraints.

For example, with respect to the media units being STBs, the STBs may be configured with event logging parameters for any number of parameters associated with operation of the STBs, such as provisioning and configuration successes and failure and/or events related to the health of the media unit and/or network.

Block 104 relates to instructing one or more of the media units to operate according to the event logging configurations. The media units may be instructed in any number of operations, such as through signaling from the network element and/or direct programming through a manufacturer or vendor thereof. For example, if the media units are STBs, the STBs may be programmed by a vendor and/or programmed through signals from a headend unit or other similar programming entity.

The instructions may be configured to support any number of media units, which may be provided by any number of vendors. One or more sets of instructions may be provided for one or more media units. The instructions may be specific to an individual media unit and/or common to a group of media units.

The instructions may include any number of parameters, commands, and other features to facilitate executing the operations associated with the event logging configurations. The instructions may include features associated with performing event detection and data logging operations, as described below in more detail. The event detection may include any number of operations, including detecting event occurrences by monitoring any number of operation parameters, operation conditions, inputs and outputs, and other features associated with the operation and/or control of the media units.

Block 106 relates to determining occurrence of one of more of the events specified in the event logging configurations. Event occurrence may be determined by the media device based on any number of features and parameters associated therewith. The media unit may include a memory or other table of information which may include a listing of event parameters and/or other features associated with the events. The memory and/or table may be analyzed by a processor or other controller of the media unit to determine the occurrence of an event. For example, the operating conditions, parameters, etc. of the media unit may be compared against event definitions stored within the table such that an event may be determined if the parameters match one or more of the event definitions.

Block 108 relates to logging data associated with one or more of the events. The data may include information associated with any number of parameters related or attendant to the event, such as the severity or priority level of the event, the time and date on which it occurred, the name of the manufacturer of the media unit, a number which uniquely identifies the event, and/or descriptive event detail.

The data may be logged into a memory or other feature associated with the media unit having capabilities for storing the logged data. The logged data my be stored on the media unit or on a feature in communication therewith. The media unit may include volatile and non-volatile memory portions for storing the data. For example, the media unit may include a volatile memory portion which is erased periodically and a permanent or non-volatile memory, such as a hard-drive, Flash Memory chip, or other feature permanently attached to the unit and/or a removable memory element, such as a thumb-driver, PCMCIA card, or other feature.

Data may be logged to either or both of the memories. For example, events of low priority or low severity may be logged into volatile memory, whereby on reboot of the media unit, the event will be cleared from memory. In contrast, events of high priority or high severity may be logged into non-volatile memory so that the event information persists in memory after a reboot.

Block 112 relates to retrieving some or all of the of the logged data. In accordance with one non-limiting aspect of the present invention, the media unit may be configured with interactive or non-interactive capabilities. For example, the media unit may be considered to be interactive if it has certain network communication capabilities, such as those associated with SNMP, and it may be consider to be non-interactive if it does not have certain network communication capabilities and/or if it is not programmed to utilize certain network communication capabilities. For exemplary purposes, one aspect of the present invention may include determining the media unit to be interactive if the logged data can be queried (i.e., requested and retrieved) by the network element and to be non-interactive if the logged data cannot be queried by the network element.

Block 114 relates to the media unit having interactive capabilities and the network element querying one or more of the media units for logged data. The network element may be configured to automatically query one or more of the media units on a periodic basis, such as for performing audits and otherwise monitoring operation of the media units. Likewise, the network element may be directed by a system operator or other user to query one or more of the media units. The network element may include a user interface or other feature to facilitate querying one or more of the media units.

Block 116 relates to the queried media units parsing a query request to determine what information is requested and whether the requested information is available. In some case, multiple queries may be communicated to one or more of the media units. The media units may be provided by different vendors and/or associated with different functions (i.e., one queried media unit may be a STB and one may be a DVR). A given media unit may not be able to respond to all the query requests, as some of the queries may request information which is unavailable from the media unit and/or the queries may be in a protocol or format which is unknown to the media unit. The media units may be configured to selectively determine which one or more queries requires or is suitable for a reply.

Block 118 relates to transmitting logged data associated with the queries. The data may be transmitted according to any number of protocols and signaling standards. For example, requested information may be collected by the media unit and packaged into a message for transportation to the network element. The message may include identifiers and other information for associating the message with the originating media unit.

The network element may be configured to tabulate or otherwise review and organize the transmitted messages as they arrive. It may be configured to generate reports, warning, and other messages or outputs as a function of the received data. The network element may include a program, logic, or other feature for automatically checking or otherwise reviewing the data for support issues and to generate service request to technicians or other personnel as a function thereof. The support issues may be determined from indicators in the logged data and/or from a comparison with a lookup table or other features which may list appropriate operating characteristics for the media unit, whereby support issues are determined if the logged data indicates a deviation from the appropriate operating characteristics. This may be advantageous in detecting operation problems, capacities, and other conditions associated with the media units Block 120 relates to the network element or other feature remotely controlling the media unit as a function of the information transmitted in block. The network element may communicate control commands and configuration profiles to control operations of the media unit. This may be advantageous in supporting customer calls whereby operating parameters of the customers media unit, STB for example, may be queried by the network element, analyzed by a remotely located technician, and corrected through signaling generated by the technician. This may save the system operator the expense and time of dispatching a field technician to the customer's location. Of course, the present invention contemplates any number of remote control options and is not intended to be limited to the foregoing.

Block 124 relates the media unit having a non-interactive setting such that the media unit may transmit the stored information as a function of an event, and not necessarily at the request of the network element. For example, the event logging configuration of the media unit may include transmission protocols or procedures for instructing the media unit to transmit logged data to the network element. The media unit may be configured to transmit data, for example, at predefined intervals and/or after specific events, which may be events for which data is logged and/or other events which simply trigger the transmission of information.

Block 126 relates to generating a message having the logged data. The message may be generated to include a selectable portion of some or all of the logged data. The message may be generated according to the logging configurations and/or according to instructions associated with one of the events. For example, one of the events may specify collecting logged data periodically throughout a period of time and automatically transmitting the collected information.

The message may be generated and formatted to support any number of protocols and applications, such as SNMP. The messages may be automatically generated and formatted to facilitate analysis by technicians and other individuals associated with the system provider. Message associated with problems, malfunctions, and other events requiring customer assistance, be generated with a specific code or indicator to facilitate the processing thereof, such as to expedite deliverance of high priority or severity issues to customer service representatives.

Block 128 relates to transmitting the message to the network element. The message may be transmitted according to any number of protocols and applications. As described above, the messages may be tabulated or otherwise analyzed by the network element, such as for use in identifying customer problems and media unit malfunctions. The message may be transmitted at regular or other periodic intervals and/or upon occurrence of an event, such as after a malfunction or other event.

The network element may be configured to tabulate or otherwise review and organize the transmitted messages, as they arrive. It may be configured to generate reports, warning, and other messages or outputs as a function of the received data. The network element may include a program, logic, or other feature for automatically checking or otherwise reviewing the data for support issues and to generate service request to technicians or other personnel as a function thereof. The support issues may be determined from indicators in the logged data and/or from a comparison with a lookup table or other features which may list appropriate operating characteristics for the media unit, whereby support issues are determined if the logged data indicates a deviation from the appropriate operating characteristics. This may be advantageous in detecting operation problems, capacities, and other conditions associated with the media units Block 130 relates to the network element or other feature remotely controlling the media unit as a function of the information transmitted in block. The network element may communicate control commands and configuration profiles to control operations of the media unit. This may be advantageous in supporting customer calls whereby operating parameters of the customers media unit, STB for example, may be queried by the network element, analyzed by a remotely located technician, and corrected through signaling generated by the technician. This may save the system operator the expense and time of dispatching a field technician to the customer's location. Of course, the present invention contemplates any number of remote control options and is not intended to be limited to the foregoing.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A method of monitoring settop box (STB) activities, the method comprising:
configuring the STB to respond to a number of events;
configuring the STB to log data in response to occurrence of one or more of the events, the logged data being associated with the corresponding event; and
configuring the STB to store the logged data in a manner suitable for use in monitoring activities of the STB.

2. The method of claim 1 further comprising configuring the STB to manage the logged data by storing the logged data for subsequent communication.

3. The method of claim 2 further comprising configuring the STB to include network communication capabilities and configuring a network element to request and retrieve at least a portion of the stored data from the STB according to the network communication capabilities.

4. The method of claim 3 further comprising configuring the STB to include SNMP capabilities such that that the stored data may be requested and retrieved according to SNMP protocols.

5. The method of claim 3 further comprising configuring the network communication capabilities of the STB to permit the STB to respond to one or more network queries, the network queries associated with retrieving logged data from the STB and transporting the logged data to the network element.

6. The method of claim 5 further comprising configuring the STB to respond to a predefined set of network queries such that the network element must request data according to one or more of the network queries within the set.

7. The method of claim 6 further comprising configuring the network element to display a selectable number of network queries on a graphical user interface, the graphical user interface being suitable for an operator of the network element to select queries for retrieving data from the STB.

8. The method of claim 5 further comprising configuring the network element to automatically query the STB according one or more of the network queries.

9. The method of claim 8 further comprising configuring the network element to periodically query the STB for logged data and to identify support issues, the support issued being determined by the network element as a function of the logged data retrieved through the periodic querying.

10. The method of claim 2 further comprising configuring the STB to automatically transmit at least a portion of the logged data to a network element.

11. The method of claim 10 further comprising configuring the STB to automatically transmit the logged data in response to one or more events.

12. The method of claim 11 further comprising configuring the network element to provide event instructions to the STB, the event instructions instructing the STB to respond to specific events.

13. The method of claim 1 further comprising configuring the STB to transmit the logged data according to SNMP, HTTP, Syslog, or TFTP protocols.

14. The method of claim 12 further comprising configuring the network element with a graphical user interface, configuring the graphical user interface to include a number of selectable events which may be selected by an operator, and configuring the network element to instruct the STB as a function of the events selected by the operator through the graphical user interface.

15. The method of claim 2 further comprising configuring the STB to store the logged data on a memory of the STB.

16. The method of claim 14 further comprising configuring the STB to store the logged data on a volatile or non-volatile memory as a function of the event associated therewith.

17. A method of monitoring media units, the method comprising:
configuring the media units to respond to a number of events;
configuring the media units to log data in response to occurrence of one or more of the events, the logged data being associated with the corresponding event; and
configuring the media units to transmit at least a portion of the logged data to a network element for monitoring.

18. The method of claim 16 further comprising configuring one or more of the media units to transmit the logged data upon receipt of a query from the network element.

19. The method of claim 16 further comprising configuring one or more of the media units to automatically transmit the logged data to the network element.

20. The method of claim 16 further comprising configuring the network element to periodically query the media units for logged data and to identify support issues, the support issued being determined by the network element as a function of the logged data retrieved through the periodic querying.

21. The method of claim 16 further comprising configuring the network element with a graphical user interface, configuring the graphical user interface to include a number of selectable events which may be selected by an operator, and configuring the network element to query the media units as a function of the events selected by the operator through the graphical user interface.

22. An electronic system of providing electronic services to customers, the services being provided over an electronic network and with the assistance of a number of media units, the system comprising:
wherein the media units are configured to respond to a number of events and to log data in response to occurrence of one or more of the events, the logged data being associated with the corresponding event; and
a network element configured for receiving the logged data from the media units and for outputting information associated with monitoring the media units, the outputted information being determined as a function of the logged data.

23. The system of claim 22 wherein one or more of the media units is configured to transmit the logged data upon receipt of a query from the network element.

24. The system of claim 22 wherein one or more of the media units is configured to automatically transmit the logged data to the network element.

25. The system of claim 24 wherein the media units are configured to transmit the logged data as a function of one or more events occurrences.

26. The system of claim 22 wherein the network element is configured to periodically query the media units for logged data.

27. The system of claim 22 wherein the network element is configured to include a graphical user interface, the graphical user interface including a number of selectable events which may be selected by an operator, wherein the network element queries the media units as a function of the selected events.

28. The system of claim 22 wherein the network element is configured to include a graphical user interface, the graphical user interface including a number of selectable events which may be selected by an operator, wherein the network element programs the media units to log data as a function of the selected events for subsequent transmission to the network element.

29. The system of claim 22 wherein the media units are settop boxes (STBs).

30. The system of claim 29 wherein the STBs are configured to communicate with the network element according to SNMP, HTTP, Syslog, or TFTP protocols.
